(19) United States
(12) Patent Application Publication
(10) Pub. No.: US 2025/0045255 A1
(43) Pub. Date: Feb. 6, 2025

(54) INTELLIGENT ADAPTATION OF A SCHEMA OF A RELATIONAL DATABASE TO A SOURCE SCHEMA

(71) Applicant: Dell Products L.P., Round Rock, TX (US)

(72) Inventors: Ravish Sachdeva, Jammu (IN); Thyagarajan R, Bangalore (IN)

(73) Assignee: Dell Products L.P., Round Rock, TX (US)

(21) Appl. No.: 18/466,109

(22) Filed: Sep. 13, 2023

(30) Foreign Application Priority Data
Aug. 2, 2023 (IN) 202311052043

(51) Int. Cl. G06F 16/21; G06F 16/22; G06F 16/28

(52) U.S. Cl. CPC G06F 16/211; G06F 16/2282; G06F 16/284

(57) ABSTRACT

An example methodology includes, by a relational database management system (RDMS), receiving data for writing to a relational database, determining a schema associated with the data, and comparing the schema to existing schemas in the relational database to determine whether there is a schema change. The method also includes, responsive to a determination that there is a schema change, applying the schema change to the relational database, so as to adapt a schema of the relational database to the schema associated with the data, wherein the determination that there is a schema change is based on the comparing the schema to the existing schemas. The method further includes writing, by the RDMS, the data to the relational database.

### BACKGROUND

Data is important to modern organizations. For example, telemetry provides valuable insights into customer behavior, market trends, and business operations. Today, organizations are processing massive amounts of data on a daily basis. Organizations often utilize databases, such as structured query language (SQL) databases, to store and retrieve information in an organized manner. For example, an organization may use relational databases to store and retrieve telemetry data, business data, scientific data, and other types of data.

Atomicity, consistency, isolation, and durability (ACID) refers to a standard set of properties that guarantee database transactions are processed properly. According to ACID, a database is consistent if and only if the database contains the results of successful transactions. Any database that is ACID-compliant will ensure that only successful transactions are processed. If a failure occurs before a transaction is complete, no data will be changed in the database. Applying the ACID properties to each modification of a database is the best way to maintain the accuracy and reliability of the database.

A database schema is a description that defines in a formal language the structure of a database. In other words, a schema is a blueprint of the logical layout of the database, outlining how the data is organized and the relationships between the different elements within the database. While NoSQL databases have the advantage of having no defined schema, NoSQL databases are not suitable for applications where ACID properties are critical. In contrast to NoSQL databases, relational databases (also known as SQL databases) provide for a more rigid, structured way of storing data and conform to ACID properties.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a relational database management system (RDMS), receiving data for writing to a relational database, determining a schema associated with the data, and comparing the schema to existing schemas in the relational database to determine whether there is a schema change. The method also includes, responsive to a determination that there is a schema change, applying the schema change to the relational database, so as to adapt a schema of the relational database to the schema associated with the data, wherein the determination that there is a schema change is based on the comparing the schema to the existing schemas. The method further includes writing, by the RDMS, the data to the relational database.

In some embodiments, applying the schema change to the relational database includes creating a table in the relational database, and writing the data to the relational database includes ingesting the data into the table.

In some embodiments, applying the schema change to the relational database includes creating a column in a table in the relational database, and writing the data to the relational database includes ingesting the data into the column in the table. In some such embodiments, the column in the table is created in a data type associated with the data.

In some embodiments, comparing the schema to existing schemas includes deducing a column type of a column in a table in the relational database, wherein the column type is deduced using the data.

In some embodiments, deducing the column type includes determining whether the data is of a type timestamp.

In some embodiments, deducing the column type includes determining whether the data has only numeric characters.

In some embodiments, deducing the column type includes determining whether the data has only numeric symbols and decimal points.

In some embodiments, deducing the column type includes determining whether the data has a single decimal point.

In some embodiments, the method also includes, responsive to the determination that there is a schema change, generating, by the RDMS, an event that represents the schema change.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process including receiving data for writing to a relational database, determining a schema associated with the data, and comparing the schema to existing schemas in the relational database to determine whether there is a schema change. The process also includes, responsive to a determination that there is a schema change, applying the schema change to the relational database, so as to adapt a schema of the relational database to the schema associated with the data, wherein the determination that there is a schema change is based on the comparing the schema to the existing schemas. The process further includes writing the data to the relational database.

According to another illustrative embodiment provided to illustrate the broader concepts described herein, a non-transitory machine-readable medium encodes instructions that when executed by one or more processors cause a process to be carried out, the process including receiving data for writing to a relational database, determining a schema associated with the data, and comparing the schema to existing schemas in the relational database to determine whether there is a schema change. The process also includes, responsive to a determination that there is a schema change, applying the schema change to the relational database, so as to adapt a schema of the relational database to the schema associated with the data, wherein the determination that there is a schema change is based on the comparing the schema to the existing schemas. The process further includes writing the data to the relational database.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a block diagram of an illustrative system for intelligent adaptation of destination schemas to source schemas, in accordance with an embodiment of the present disclosure.

FIG. 5 is a flow diagram of an example process for adapting a destination schema to a source schema, in accordance with an embodiment of the present disclosure.

FIG. 6 is a flow diagram of an example process for determining whether there is a schema change, in accordance with an embodiment of the present disclosure.

FIG. 7 is a flow diagram of an example process for deducing a column type of a column in a table, in accordance with an embodiment of the present disclosure.

### DETAILED DESCRIPTION

A relational database is a database that is based on the relational model, an intuitive way of structuring data into rows and columns, which collectively form a table. A schema of a database generally refers to the configuration of the data contained in a database. Typically, a schema of a database includes a list of the tables used to represent the data in the database, and describes the structure of each table as well as any constraints on the data stored in that table. Since the schema provides the key to understanding the configuration of the data in the database, the schemas at the source of data and the destination of data should be in sync. However, database users frequently make schema modifications. For example, schema changes may be part of application or database upgrades and/or releases or due to some flaw in the original design of the database. Detecting and syncing schema changes is non-trivial and typically performed by data scientists who manually change the destination schema of the database whenever there is a change to the source schema. Manual intervention to change the destination schema to be in sync with the source schema is both inefficient and prone to errors.

Disclosed herein are concepts, structures, and techniques for intelligent adaptation of destination schemas to source schemas. In some embodiments, a schema of a relational database may be adapted to a source schema associated with data to be written to the relational database. In some such embodiments, the adaptation of the schema of the relational database (i.e., the destination schema) to the source schema can be achieved by comparing the source schema to existing schemas in the relational database. The comparison may be to determine whether there are differences between the source schema and the existing schemas in the relational database (e.g., to determine whether there is a schema change to the relational database). If there is a schema change, the schema change may be applied to the relational database, so as to adapt the schema of the relational database to the source schema. As a result, the schema of the relational database is synchronized to the source schema. This in turn can allow for better utilization and improved performance of the system (better utilization and improved performance of the relational database) by minimizing, and in some cases significantly minimizing, the time the system is unavailable due to syncing of the schema changes, for example. Adaptation of the schema of the relational database (i.e., the destination schema) to the source schema can also ensure that data integrity of the relational database is maintained. Numerous configurations and variations will be apparent in light of this disclosure.

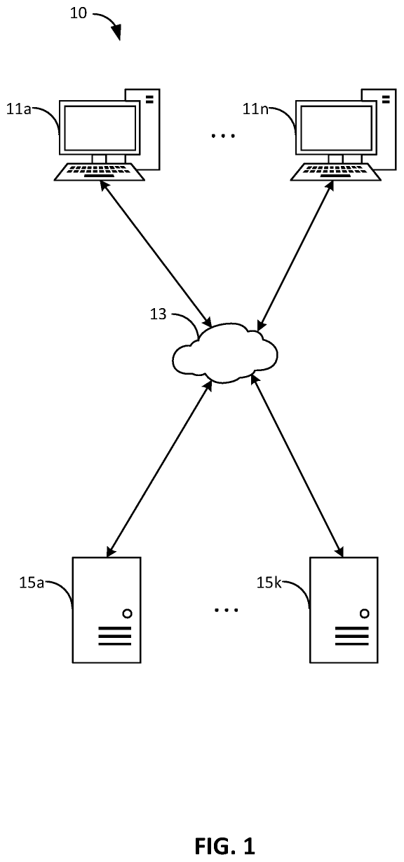

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to as a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

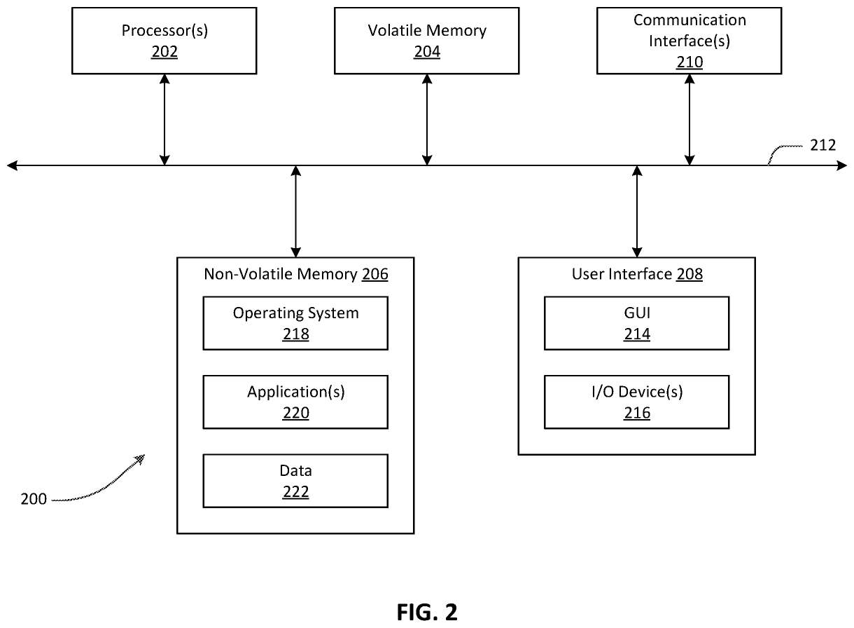

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

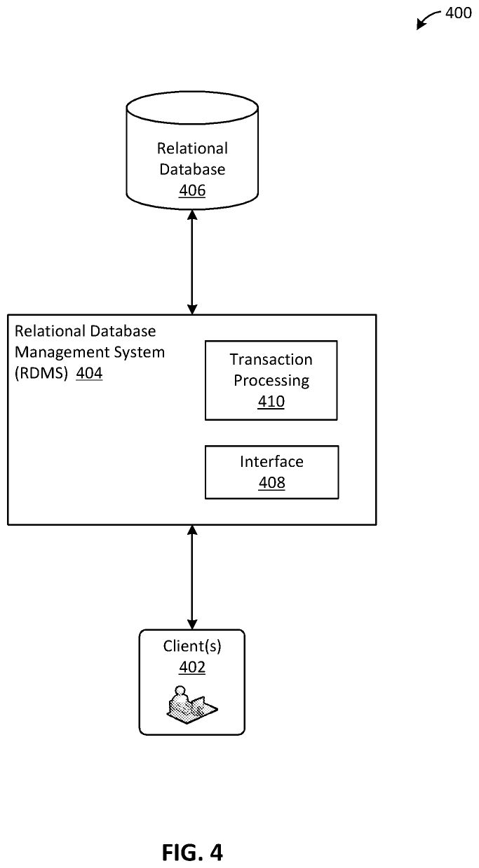

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 through 7). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital, or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

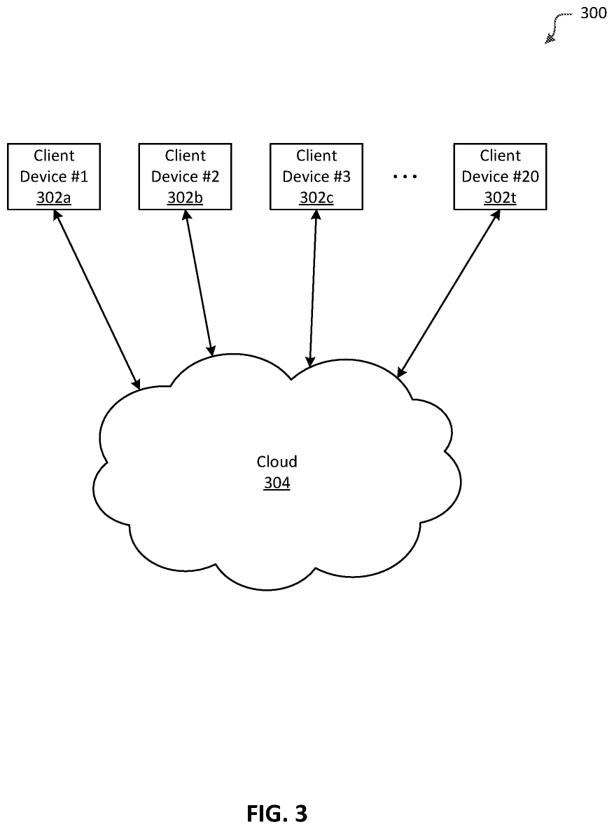

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of clients 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a Service (SaaS), Platform as a Service (PaaS), Infrastructure as a Service (IaaS), and/or Desktop as a Service (DaaS), for example. IaaS may refer to a user renting the use of infrastructure resources that are needed during a specified time period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

Referring now to FIG. 4, shown is a block diagram of an illustrative system 400 for intelligent adaptation of destination schemas to source schemas, in accordance with an embodiment of the present disclosure. In particular, according to some embodiments, the adaptation can be of schemas of a relational database to source schemas. Illustrative system 400 includes one or more clients 402 configured to communicate with a relational database management system (RDMS) 404 via one or more communication networks (not shown). The communication networks can include, for example, the Internet, LANs, WANs, MANs, etc.

In some embodiments, system 400 may form part of a network environment, such as network environment 10 of FIG. 1. For example, in some such embodiments, clients 402 of FIG. 4 may correspond to client machines 11 of FIG. 1 and RDMS 404 of FIG. 4 may correspond to one or more server machines 15 of FIG. 1. In some embodiments, system 400 may form part of a cloud computing environment, such as cloud computing environment 300 of FIG. 3. For example, in some such embodiments, clients 402 of FIG. 4 may correspond to client devices 302a-302t of FIG. 3 and RDMS 404 of FIG. 4 may correspond to a virtual or physical server providing a cloud-based service, such as SaaS.

Clients 402 may include any type of client devices configured to install and/or run applications (or “apps”). For example, a representative client 402 may run a client application, such as a web client or a dedicated application, that a user can use to access and interact with RDMS 404. For example, a user may use their client 402 to interact with RDMS 404 to manage a relational database 406 (e.g., utilize RDMS 404 to write data to relational database 406). As used herein, the term “user” refers, in addition to its ordinary meaning, to a person or thing that uses something, either stated or implied. For example, a user can be any person, system, or other entity that uses a database management system (e.g., RDMS 404) to store, retrieve, and manipulate data in a database (e.g., relational database 406). A user may be a human or a non-human (e.g., an application or a system).

To promote clarity in the drawings, FIG. 4 shows a single client 402 communicably coupled to RDMS 404. However, embodiments of RDMS 404 can be used to service many clients (e.g., clients 402) associated with one or more organizations and/or users.

Generally, RDMS 404 serves as an interface between users and relational database 406. RDMS 404 is operable to allow users to create, read, update, and delete data relational database 406. For example, RDMS 404 may correspond to a relational database management system such as MYSQL, POSTGRE SQL, SQL SERVER, etc. In the example of FIG. 4, RDMS 404 can include an interface module 408 and a transaction processing module 410. RDMS 404 can include other hardware and software resources such as those described herein with respect to computing device 200 of FIG. 2.

Interface module 408 operates to provide an interface to RDMS 404. Interface module 408 may include a user interface, such as a graphical user interface (GUI) and/or a command line interface, with which a user can interact with RDMS 404 through the formation and sending of a request. Additionally or alternatively, interface module 408 may include an application programming interface (API) which can be used to communicate with RDMS 404, for example, to send a request. In any case, interface module 408 can facilitate the sending of requests by, for example, users of clients 402, and the receiving of such requests by RDMS 404. The requests received by interface module 408 may include database queries, such as action queries to perform operations (e.g., insert, update, delete, etc.) on data in relational database 406.

Transaction processing module 410 is operable to process transactions against relational database 406. The transactions generally represent any change in relational database 406. For example, transaction processing module 410 may process a database transaction in response to a request from client 402 (e.g., in response to a request received by interface module 408). A database transaction is generally defined by one or more instructions (e.g., a set of instructions) delineated by two keywords which mark the beginning and end of the transaction, respectively. For example, in MYSQL and POSTGRESQL, the two keywords are “START TRANSACTION” and “COMMIT,” and in SQL SERVER, the two keywords are “BEGIN TRANSACTION” and “COMMIT TRANSACTION.”

Depending on the type of transaction against relational database 406, transaction processing module 410 may adapt a schema of relational database 406 to a source schema. For example, in response to a request to write data to relational database 406, transaction processing module 410 can process a transaction to write the data to relational database 406. In some cases, the transaction to write the data to relational database 406 may include adapting the schema of relational database 406 to a schema associated with the data. That is, in some cases, transaction processing module 410 may need to adapt the schema of relational database 406 to the schema associated with the data (i.e., the source schema) to process the transaction to write the data to relational database 406. As a result, the schema of relational database 406 is in sync with the schema associated with the data (i.e., the source schema). Note that a request to write data to relational database 406 is merely illustrative and is not intended to be a complete list of requests/transactions that may include adapting the schema of relational database 406 to a source schema (e.g., a schema of the data associated with the request). For example, operations other than write requests to relational database 406 may include adapting the schema of relational database 406 to a source schema.

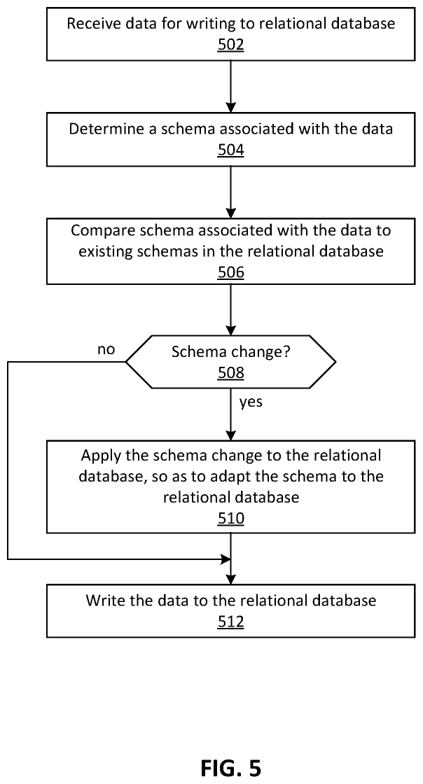

FIG. 5 is a flow diagram of an example process 500 for adapting a destination schema to a source schema, in accordance with an embodiment of the present disclosure. Illustrative process 500 may be implemented, for example, within transaction processing module 410 of FIG. 4 to adapt a schema of a relational database (e.g., relational database 406 of FIG. 4) to a source schema.

With reference to process 500 of FIG. 5, at 502, data for writing to a relational database (e.g., relational database 40 of FIG. 4) may be received. For instance, a user may use a client device (e.g., client 402 of FIG. 4) to send a request to write data to the relational database. The data to be written to the relational database may be contained in a file, such as a JavaScript Object Notation (JSON) file, an SQLITE file, a comma-separated values (CSV) file, and an Extensible Markup Language (XML) file, or other suitable data file, which is provided with the request to write data to the relational database.

At 504, a schema associated with the data may be determined. As mentioned previously, the schema provides an understanding of the configuration of the data in the relational database (e.g., describes how the data relates to the tables in the relational database). To determine the schema associated with the data that is to be written to the relational database, according to some embodiments, the type of file provided with the request, and which contains the data can be determined. For example, determining the type of file may be needed as different types of files may organize the data differently within the file. The data to be written to the relational database can then be extracted from the file. The data extracted from the file can be transformed to place the data into a tabular format. For example, in the tabular format, the data to be written can be organized into rows (also known as “records” or “tuples”) and columns (also known as “attributes”), which collectively form a table. Each row in the table may be identified by a unique key. The columns of the table may hold attributes of the data, and each record may have a value (or “data point”) for the individual attributes. Placing the data into the tabular format allows for determining the schema associated with the data (i.e., determining the schema of the data). Placing the data into the tabular format also prepares the data for processing to write the data to the relational database.

At 506, the schema associated with the data may be compared to existing schemas in the relational database. The schema associated with the data, which may be understood to be the source schema, may be compared to existing schemas in the relational database, which may be understood to be the destination schema, to determine whether there is a schema change. That is, the structure of the table that contains the data to be written to the relational database (i.e., the source schema) may be compared to the structures of existing tables in the relational database (i.e., the destination schema) to determine whether there is a change (or “alteration”) to any one of the tables in the relational database. In other words, the comparison of the structure of the table that contains the data to the structures of the existing tables may be to determine whether a table for writing the data to the relational database already exists in the relational database or the internal structure of the existing table has changed.

At 508, a check may be performed to determine whether there is a schema change. The determination of whether there is a schema change may be based on the comparison of the schema associated with the data that is to be written to the relational database to the existing schemas in the relational database. Non-limiting examples of a schema change include an unknown table in the relational database (e.g., the table that contains the data to be written to the relational database is not in the relational database), a table with a new column, a table with a missing column, a table with a different column order, and an existing column in a table with a modified data type. Generally, a schema change refers to any change to the structure of a table in the relational database including a table which may not yet exist in the relational database.

If, at 508, it is determined that there is a schema change, then, at 510, the schema change may be applied to the relational database. For example, the specific differences between the schema associated with the data (i.e., the source schema) and the existing schemas in the relational database (i.e., the destination schema) can be identified. The identified differences can then be applied to the relational database to adapt a schema of the relational database to the schema associated with the data (e.g., adapt the destination schema to the source schema). Applying the schema change to the relational database prepares a table in the relational database for receiving the data to be written to the relational database.

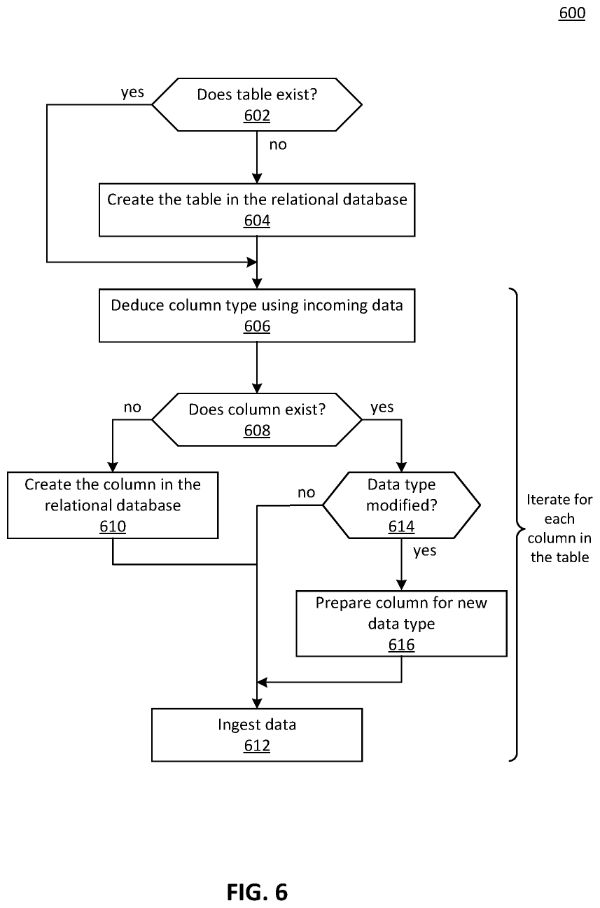

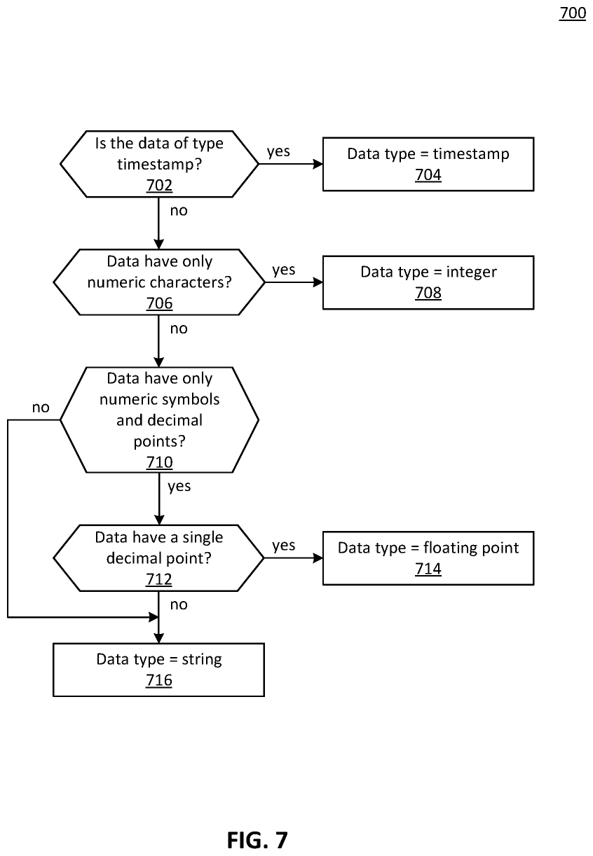

Otherwise, if, at 508, it is determined that there is no schema change or upon applying the schema change to the relational database at 510, then, at 512, the data may be written to the relational database. For example, the data to be written to the relational database may be ingested into an appropriate table and, more particularly, into the records in the table in the relational database. Further description of the comparing of the schema associated with the data and the existing schemas in the relational database to determine whether there is a schema change and other processing related to determination of a schema change and which can be implemented within transaction processing module 410 is provided below at least with respect to FIGS. 6 and 7.

In some embodiments, additional operations may be performed. In one embodiment, events may be generated to track the schema changes. For example, upon determining that there is a schema change, such as a change to the structure of an existing table in the relational database, an event can be generated to record or document the particular schema change. The generated event can be understood to contain metadata about the particular schema change. The event can be stored (or “logged”) and subsequently used to validate the schema change. For example, a user having knowledge of the data and the relational database can analyze the event (e.g., analyze the metadata) and determine whether the change in the schema is an intended or unintended (i.e., accidental) change.

FIG. 6 is a flow diagram of an example process 600 for determining whether there is a schema change, in accordance with an embodiment of the present disclosure. Illustrative process 600 may be implemented, for example, within transaction processing module 410 of FIG. 4 to determine whether there is a schema change in a relational database (e.g., relational database 406 of FIG. 4).

With reference to process 600 of FIG. 6, at 602, a check may be performed to determine whether the table exists in the relational database. The table in this instance is the table that contains the data to be written to the relational database. The check at 602 may be to determine whether the table that contains the data to be written to the relational database exists in the relational database. In other words, the check may be to determine whether the table that contains the data to be written to the relational database is a new table which does not exist in the relational database.

If, at 602, it is determined that the table that contains the data to be written to the relational database does not exist in the relational database, then, at 604, a table (e.g., a new table) may be created in the relational database. The table created in the relational database may be for containing the data that is to be written to the relational database. In this instance, the table that contains the data to be written not existing in the relational database (i.e., the table that contains the data to be written being a new table in the relational database) can be understood to be a schema change to the relational database. As a result of creating the new table in the relational database, the schema of the relational database is adapted to the schema of the source of the data to be written to the relational database.

In some embodiments, an event may be generated to record the schema change to the relational database (e.g., creation of the new table in the relational database). The recorded event can subsequently be used to validate the schema change to the relational database. In some embodiments, an alert may be generated informing of the schema change to the relational database (e.g., notify the user writing the data to the relational database of the creation of the new table in the relational database).

Otherwise, if, at 602, it is determined that the table that contains the data to be written to the relational database does exist in the relational database or upon creating the new table for the data in the relational database at 604, operations 606 to 612 may be iterated for each column in the table.

At 606, a column type of the column in the table may be determined using the incoming data in the column. The incoming data is the data that is to be written to the relational database. The incoming data contained in a column may be used to deduce a column type of the column. That is, the type of column may be deduced based on the data type associated with the incoming data in the column. For example, if the column contains data of data type integer (e.g., the column contains integer data), it may be deduced that the column is of column type integer. As another example, if the column contains data of data type floating point (e.g., the column contains floating point data), it may be deduced that the column is of column type floating point. In any case, the column type of a column may be deduced and used to determine whether there is a schema change to the relational database caused by a change or alteration in the column type of the column. Further description of deducing a column type of a column in a table is provided below at least with respect to FIG. 7.

At 608, a check may be performed to determine whether the column exists in the table. More particularly, the check may be to determine whether the column that contains the data to be written exists in the table in the relational database. It may be that the table in the relational database which is to receive (e.g., contain) the data to be written does not include a column that is appropriate to receive the data that is to be written to the relational database. For example, the column that contains the data to be written may be of column type integer, but the table in the relational database that is to receive the data does not include a column that is appropriate to receive integer data.

If, at 608, it is determined that the column that contains the data to be written does not exist in the table that is to receive the data in the relational database, then, at 610, a column (e.g., a new column) may be created in the table in the relational database. The new column that is created in the table may be configured to be of the same column type as the column that contains the data to be written. For example, if the column that contains the data to be written is of column type integer, the new column that is created can be configured to be of column type integer. As a result, the new column created in the table in the relational database is appropriate to receive the integer data that is to be written to the relational database. In this instance, the column that contains the data to be written not existing in the table that is to receive the data the relational database (i.e., the column that contains the data to be written being a new column in the table in the relational database) can be understood to be a schema change to the relational database. As a result of creating the new column in the table in the relational database, the schema of the relational database is adapted to the schema of the source of the data to be written to the relational database.

In some embodiments, an event may be generated to record the schema change to the relational database (e.g., creation of the new column in the table in the relational database). The recorded event can subsequently be used to validate the schema change to the relational database. In some embodiments, an alert may be generated informing of the schema change to the relational database (e.g., notify the user writing the data to the relational database of the creation of the new column in the table in the relational database).

At 612, the data to be written to the relational database may be ingested. In this instance, the data in the column that is to be written may be written to the new column created in the table in the relational database.

Otherwise, if, at 608, it is determined that the column that contains the data to be written does exist in the table that is to receive the data in the relational database (e.g., there is an existing column in the table in the relational database), then, at 614, a check may be performed to determine whether the data type has been modified. Here, the check may be to determine whether the type of data contained in the existing column in the table in the relational database has been modified. For example, the existing column in the table that is to receive the data in the relational database may contain integer data (e.g., the column identified to receive the data to be written may be of column type integer), but the data to be written is of a new data type (e.g., the data to be written to the relational database is of data type that is not integer data type).

If, at 614, it is determined that the data type has been modified, then, at 616, the column in the table that is to receive the data may be prepared for the new data type. That is, the existing column in the table that is to receive the data in the relational database can be configured to receive the data (e.g., the type of data) that is to be written to the relational database. For example, if the data that is to be written to the relational database is of data type string (e.g., the column contains string data), the existing column in the table that is to receive the data can be configured to receive string data. In this instance, the data type of the existing column in the table in the relational database being modified to a new data type (i.e., the type of data contained in the existing column being modified to a new data type) can be understood to be a schema change to the relational database. As a result of preparing the existing column in the table in the relational for the new data type, the schema of the relational database is adapted to the schema of the source of the data to be written to the relational database.

Otherwise, if, at 614, it is determined that the data type has not been modified or upon preparing the column in the table that is to receive the data for the new data type at 616, then, at 612, the data to be written to the relational database may be ingested. In this instance, the data in the column that is to be written may be written to the existing column in the table in the relational database. As described previously, the existing column in the table in the relational database may be prepared for a new data type in cases where the data to be written has been modified to the new data type.

FIG. 7 is a flow diagram of an example process 700 for deducing a column type of a column in a table, in accordance with an embodiment of the present disclosure. Illustrative process 700 may be implemented, for example, within transaction processing module 410 of FIG. 4 to determine a column type of a column in a table using the incoming data in the column. As previously noted, the incoming data in the column is the data that is to be written to a relational database (e.g., relational database 406 of FIG. 4).

With reference to process 700 of FIG. 7, at 702, a check may be performed to determine whether the data in the column is of type timestamp. Here, the check may be to determine whether the column contains timestamps (e.g., timestamp data). If it is determined that the data in the column is of type timestamp, then, at 704, it may be determined that the data contained in the column is of data type timestamp (e.g., “Data type=timestamp”). Based on the determination that the data contained in the column is of type timestamp, the column type of the column may be deduced to be of type timestamp (i.e., it may be deduced that the column is of column type timestamp).

If, at 702, it is determined that the data in the column is not of type timestamp, then, at 706, a check may be performed to determine whether the data in the column have only numeric characters. Here, the check may be to determine whether the column contains integers (e.g., integer data). If it is determined that the data in the column have only numeric characters, then, at 708, it may be determined that the data contained in the column is of data type integer (e.g., “Data type=integer”). Based on the determination that the data contained in the column is of type integer, the column type of the column may be deduced to be of type integer (i.e., it may be deduced that the column is of column type integer).

If, at 706, it is determined that the data in the column does not have only numeric characters (e.g., data in the column have characters other than only numeric characters), then at 710, a check may be performed to determine whether the data in the column have only numeric symbols and decimal points. Here, the check may be to determine whether the column contains floating points (e.g., floating point data) or strings (e.g., string data). If it is determined that the data in the column have only numeric symbols and decimal points, then, at 712, a check may be performed to determine whether the data in the column have a single decimal point.

If, at 712, it is determined that the data in the column have a single decimal point, then, at 714, it may be determined that the data contained in the column is of data type floating point (e.g., “Data type=floating point”). Based on the determination that the data contained in the column is of type floating point, the column type of the column may be deduced to be of type floating point (i.e., it may be deduced that the column is of column type floating point).

If, at 712, it is determined that the data in the column does not have a single decimal point (e.g., data in the column does not have decimal point or have more than one decimal point) or if, at 710, it is determined that the data in the column does not have only numeric symbols and decimal points, then, at 716, it may be determined that the data contained in the column is of data type string (e.g., “Data type=string”). Based on the determination that the data contained in the column is of type string, the column type of the column may be deduced to be of type string (i.e., it may be deduced that the column is of column type string).

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

1. A method comprising:
receiving, by a relational database management system (RDMS), data for writing to a relational database;
determining, by the RDMS, a schema associated with the data;
determining, by the RDMS, whether there is a scheme change in the relational database by comparing the schema to existing schema, wherein comparing includes deducing a column type of a column in a table in the relational database by sequentially eliminating one column type at a time from a plurality of available column types;
responsive to a determination that there is a schema change, applying, by the RDMS, the schema change to the relational database, so as to adapt a schema of the relational database to the schema associated with the data, wherein the determination that there is a schema change is based on the comparing the schema to the existing schemas; and
writing, by the RDMS, the data to the relational database.

2. The method of claim 1, wherein the applying the schema change to the relational database includes creating a table in the relational database, and wherein the writing the data to the relational database includes ingesting the data into the table.

3. The method of claim 1, wherein the applying the schema change to the relational database includes creating a column in a table in the relational database, and wherein the writing the data to the relational database includes ingesting the data into the column in the table.

4. The method of claim 3, wherein the column in the table is created in a data type associated with the data.

5. The method of claim 1, wherein the plurality of available column types include a type timestamp, a type integer, a type floating point, and a type string.

6. The method of claim 5, a first column type to be sequentially eliminated is type timestamp.

7. The method of claim 5, wherein a second column type to be sequentially eliminated is the integer type and wherein the data has only numeric characters.

8. The method of claim 5, wherein a third column type to be sequentially eliminated is a type floating point and wherein the data has only numeric symbols and a single decimal point.

9. The method of claim 5, wherein a fourth column type is sequentially determine to be a string and wherein the data has only numeric symbols and more than one decimal point.

10. The method of claim 5, further comprising, responsive to the determination that there is a schema change, generating, by the RDMS, an event that represents the schema change.

11. A system comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving data for writing to a relational database;
determining a schema associated with the data;
determining whether there is a scheme change in the relational database by comparing the schema to existing schema, wherein comparing includes deducing a column type of a column in a table in the relational database by sequentially eliminating one column type at a time from a plurality of available column types;
responsive to a determination that there is a schema change, applying the schema change to the relational database, so as to adapt a schema of the relational database to the schema associated with the data, wherein the determination that there is a schema change is based on the comparing the schema to the existing schemas; and
writing the data to the relational database.

12. The system of claim 11, wherein the applying the schema change to the relational database includes creating a table in the relational database, and wherein the writing the data to the relational database includes ingesting the data into the table.

13. The system of claim 11, wherein the applying the schema change to the relational database includes creating a column in a table in the relational database, and wherein the writing the data to the relational database includes ingesting the data into the column in the table.

14. The system of claim 13, wherein the column in the table is created in a data type associated with the data.

15. The system of claim 11, wherein the plurality of available column types include a type timestamp, a type integer, a type floating point, and a type string.

16. The system of claim 11, wherein sequentially eliminating one column type at a time from a plurality of available column types includes, in order, determining whether the data is of a type timestamp, determining whether the data has only numeric characters, determining whether the data has only numeric symbols and decimal points, determining whether the data has a single decimal point.

17. A non-transitory machine-readable medium encoding instructions that when executed by one or more processors cause a process to be carried out, the process including:
receiving data for writing to a relational database;
determining a schema associated with the data;
determining whether there is a scheme change in the relational database by comparing the schema to existing schema, wherein comparing includes deducing a column type of a column in a table in the relational database by sequentially eliminating one column type at a time from a plurality of available column types;
responsive to a determination that there is a schema change, applying the schema change to the relational database, so as to adapt a schema of the relational database to the schema associated with the data, wherein the determination that there is a schema change is based on the comparing the schema to the existing schemas; and
writing the data to the relational database.

18. The machine-readable medium of claim 17, wherein the applying the schema change to the relational database includes creating a table in the relational database, and wherein the writing the data to the relational database includes ingesting the data into the table.

19. The machine-readable medium of claim 17, wherein the applying the schema change to the relational database includes creating a column in a table in the relational database, and wherein the writing the data to the relational database includes ingesting the data into the column in the table.

20. The machine-readable medium of claim 17, wherein the plurality of available column types include a type timestamp, a type integer, a type floating point, and a type string.
